(19) United States
(12) Patent Application Publication
(10) Pub. No.: US 2017/0234089 A1
(43) Pub. Date: Aug. 17, 2017

(54) Mixing Tank and Method of Use

(71) Applicant: Tom Gurtner, (US)

(72) Inventor: Danny Ness, Metairie, LA (US)

(21) Appl. No.: 15/387,647

(22) Filed: Dec. 22, 2016

Related U.S. Application Data
(63) Continuation of application No. 12/948,517, filed on Nov. 17, 2010, now Pat. No. 9,528,333.
(60) Provisional application No. 61/261,995, filed on Nov. 17, 2009.

(51) Int. Cl. E21B 21/06; B01F 7/24; B01F 3/10; F04C 2/16; E21B 21/00

(52) U.S. Cl. CPC E21B 21/062; F04C 2/16; E21B 21/003; B01F 3/10; B01F 7/248; B01F 2003/105; B01F 2215/0081

(57) ABSTRACT

A method of transmitting a fluid into an oil well bore provides a frame supporting a vessel, the vessel having an interior, upper and lower end portions, a conically shaped side wall, and an outlet for discharging the fluid from the vessel. A viscous polymeric material is added to the vessel interior. A discharge pipe having a vertical section is placed below the vessel, the discharge pipe being in communication with the outlet. A positive displacement pump is contained within the discharge pipe. The pump transmits fluid from the outlet into the discharge pipe downstream of the vertical pipe section or pump. The fluid is selectively transmitted to either the vessel interior (for recirculating) or into the well. Air is added to the discharge flow line downstream of the pump.

### CROSS-REFERENCE TO RELATED APPLICATIONS

This is a nonprovisional of U.S. Provisional Patent Application Ser. No. 61/261,995, filed 17 Nov. 2009.

Priority of U.S. Provisional Patent Application Ser. No. 61/261,995, filed 17 Nov. 2009, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to a specially configured mixing tank for mixing and transferring a liquid or slurry between into an oil well.

2. General Background

In the exploration of oil and gas in a marine environment, fixed, semi submersible, jack up, and other offshore marine platforms are used during drilling operations. Fixed platforms are typically used for production of oil and gas from wells after they have been drilled. Drilling and production require that specialized fluids and like supplies be transported from land based storage facilities to offshore platforms or drilling vessels. Supplies are typically transferred to offshore platforms using very large marine vessels called work boats. These work boats can be in excess of one hundred feet in length and have expansive deck areas for carrying cargo that is destined for an offshore platform. Supplies are typically transferred from a land based dock area to the marine vessel using a lifting device such as a crane or a mobile lifting and transport device such as a forklift.

Once a work boat arrives at a selected offshore platform, supplies or products are typically transferred from the deck of the work boat to the platform using a lifting device such as a crane.

Once on the deck of a drilling platform or production platform, space is at a premium. The storage of supplies on an offshore oil well drilling or production platform is a huge problem. Some specialized fluids used in the well require handling that does not shear the fluid. An example is a high viscosity fluid such as certain polymers. Many cargo transport and lifting devices have been patented. The table below lists some patents that relate generally to pallets, palletized racks, and other cargo racks.

TABLE 1

| PATENT | | |
|---|---|---|
| NO. | TITLE | ISSUE DATE |
| 2,579,655 | Collapsible Container | Dec. 25, 1951 |
| 2,683,010 | Pallet and Spacer | Jul. 6, 1954 |
| 3,776,435 | Pallet | Dec. 4, 1973 |
| 3,916,803 | Loading Platform | Nov. 14, 1975 |
| 4,165,806 | Palletizing System for Produce Cartons | Aug. 28, 1979 |
| | and the Like | |
| 4,403,556 | Drum Retainer | Sep. 13, 1983 |
| 4,828,311 | Metal Form Pallet | May 9, 1989 |
| 5,078,415 | Mobile Carrier for Gas Cylinders | Jan. 7, 1992 |
| 5,156,233 | Safety Anchor for Use with Slotted Beams | Oct. 20, 1992 |
| 5,292,012 | Tank Handling and Protection Structure | Mar. 8, 1994 |
| 5,507,237 | Lifting Apparatus for Use with Bulk Bags | Apr. 16, 1996 |
| 5,906,165 | Stackable Tray for Plants | May 25, 1999 |
| 6,058,852 | Equipment Skid | May 9, 2000 |
| 6,357,365 | Intermediate Bulk Container Lifting Rack | Mar. 19, 2002 |
| 6,371,299 | Crate Assembly and Improved Method | Apr. 16, 2002 |
| 6,422,405 | Adjustable Dunnage Rack | Jul. 23, 2002 |
| 6,668,735 | Pallet with a Plastic Platform | Dec. 30, 2003 |
| 6,725,783 | Pallet for Stacking Planographic Printing | Apr. 27, 2004 |
| | Plates Thereon | |

### BRIEF SUMMARY OF THE INVENTION

The present invention provides an improved mixer apparatus that includes a frame having upper and lower end portions. The frame supports a specially configured vessel and in internal mixer, pump and valving.

The present invention provides a method of transmitting a viscous polymeric fluid into an oil well bore. As part of the method, there is provided a frame supporting a vessel, the vessel having an interior, upper and lower end portions, a conically shaped side wall, and an outlet for discharging the fluid from the vessel.

A viscous material is added to the vessel interior.

A discharge pipe section is placed in communication with the outlet and at least in part below the vessel, the discharge pipe section being in communication with the outlet.

A positive displacement pump is placed in the discharge pipe section, the pump transmitting the fluid from the outlet into the discharge pipe downstream of the vertical pipe section.

There can be a selective transmitting of the fluid to either the vessel interior for recirculating or into the well.

Air can be added to the discharge flow line downstream of the pump.

In one embodiment, the pump includes screw conveyor.

In one embodiment, the conically shaped side wall extends to the outlet and placing the positive displacement pump entirely below the conically shaped side wall.

In one embodiment, the viscous polymeric material includes a fluid loss control product.

In one embodiment, the viscous material is a viscous polymeric material.

In one embodiment, the vessel gradually tapers downwardly to provide a larger upper portion and a smaller lower portion.

In one embodiment, a drive shaft rotates an auger that is inside the vessel.

In one embodiment, the drive shaft rotates both the screw conveyor and the auger.

In one embodiment, the pump includes a drive shaft that rotates the screw conveyor.

The present invention provides in one embodiment, a method of transmitting a viscous polymeric fluid into an oil well bore.

The method includes providing a frame supporting a vessel, the vessel having an interior, upper and lower end portions, a conically shaped side wall that tapers downwardly, and an outlet for discharging the fluid from the vessel.

The method includes adding a polymeric material to the vessel interior that is a fluid loss control product.

A discharge pipe section is placed below the vessel, the discharge pipe section being in communication with the outlet;

A positive displacement pump is placed in the discharge pipe, the pump transmitting the fluid from the outlet into the discharge pipe downstream of the vertical pipe section.

The fluid can be transmitted to either the vessel interior for recirculating or into the well.

In one embodiment, the pump has a drive shaft and the drive shaft extends into the vessel interior.

In one embodiment, the pump includes screw conveyor.

In one embodiment, the conically shaped side wall extends to the outlet and placing the positive displacement pump entirely below the conically shaped side wall.

In one embodiment, the viscous material is a viscous polymeric material.

In one embodiment, air can be added (e.g. injected) to the discharge pipe section downstream of the outlet.

In one embodiment, the vessel gradually tapers downwardly to provide a larger upper portion and a smaller lower portion.

In one embodiment, a drive shaft rotates an auger that is inside the vessel.

In one embodiment, the drive shaft rotates both the screw conveyor and the auger.

In one embodiment, the pump includes a drive shaft that rotates the screw conveyor.

The present invention provides an apparatus for transmitting a viscous polymeric fluid into an oil well bore, comprising:

The apparatus includes a frame that supports a vessel, the vessel having an interior, upper and lower end portions, a conically shaped side wall, and an outlet for discharging the fluid from the vessel.

An opening in the vessel enables the addition of a viscous material to the vessel interior.

A discharge pipe section is in communication with the outlet and extending at least in part below the vessel, the discharge pipe section being in communication with the outlet.

A positive displacement pump is placed in the discharge pipe section, the pump transmitting the fluid from the outlet into the discharge pipe downstream of the vertical pipe section.

Piping enables selective transmission of the fluid to either: 1) the vessel interior for recirculating, or 2) into the well.

A source of air includes and air inlet fitting for enabling air to be added to the discharge flow line downstream of the pump.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is an elevation view of the preferred embodiment of the apparatus of the present invention.

### DETAILED DESCRIPTION OF THE INVENTION

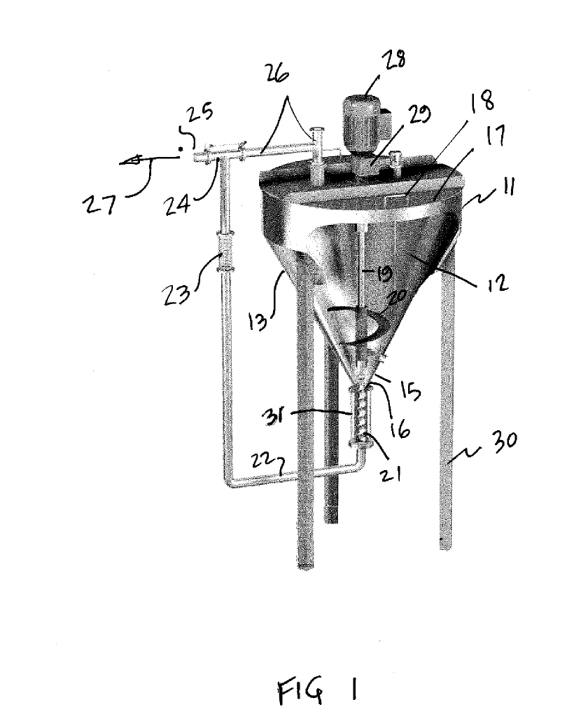

FIG. 1 shows the preferred embodiment of the apparatus of the present invention designated generally by the numeral 10. Mixing apparatus 10 and its method contemplate the addition of a viscous and/or polymeric fluid into the well bore of an oil/gas well as part of well control. Such products can include fluid loss control products such as for example “Safe-Link” from MiSwaco (www.miswaco.com). In FIG. 1, a vessel 11 is provided, supported upon frame or legs 30. Vessel 11 has interior 12. Vessel 11 has a tapered wall or cone 13. Vessel 11 has a larger upper end portion 14 and smaller lower end portion 15 due to the conical shape of the side wall or cone 13. The lower end portion 15 has an outlet which enables fluid to be discharged from vessel 11 interior 12.

A lid or cover 17 is provided on upper end portion of vessel 11. Lid or cover 17 can be hingedly mounted upon upper end portion 14 of vessel 11. Handle 18 on lid or cover 17 enables a user to open or close the vessel 11 such as when adding fluid to vessel interior 12. A drive shaft 19 rotates auger 20. The drive shaft 19 can also rotate screw conveyor 21 or a positive displacement pump. The screw conveyor 21 or positive displacement pump can be contained within a vertical section 31 of discharge piping 22. Air is preferably added to discharge piping 22 such as via air injector or air inlet 23.

Valve 24 is a directional valve that enables fluid to be either recirculated back to vessel 11 are transmitted into an oil well bore. In FIG. 1, flow line 26 is a recirculation flow line that transmits fluid from valve 24 to vessel 11 interior 12. FIG. 1 also illustrates transfer of fluid from valve 24 into a well bore as indicated schematically by the numeral 27. Valve 24 can be operated to send flow to either vessel 11 or to the well bore using an operator 25.

The following is a list of suitable parts and materials for the various elements of the preferred embodiment of the present invention.

PARTS LIST

| PART NO. | DESCRIPTION |
|---|---|
| 10 | mixer apparatus |
| 11 | vessel |
| 12 | vessel interior |
| 13 | cone/tapered wall |
| 14 | upper end portion |
| 15 | lower end portion |
| 16 | outlet |
| 17 | lid/cover |
| 18 | handle |
| 19 | drive shaft |
| 20 | auger |
| 21 | screw conveyor/positive displacement pump |
| 22 | discharge pipe |
| 23 | air injector/air inlet |
| 24 | valve |
| 25 | operator |
| 26 | return flow line |
| 27 | arrow - flow to well |
| 28 | motor |
| 29 | gear box |
| 30 | frame/legs |
| 31 | vertical section |

All measurements disclosed herein are at standard temperature and pressure, at sea level on Earth, unless indicated otherwise.

The foregoing embodiments are presented by way of example only; the scope of the present invention is to be limited only by the following claims.

1. A method of transmitting a viscous polymeric fluid into an oil well bore, comprising the steps of:
a) providing a frame supporting a vessel, the vessel having an interior, upper and lower end portions, a vessel top, a vessel side wall, an inlet on the vessel top and an outlet for discharging the fluid from the vessel, the frame including one or more feet that space the vessel above an underlying support surface;
b) adding a viscous material to the vessel interior;
c) placing a discharge pipe section in communication with the outlet and at least in part below the vessel, the discharge pipe section being in communication with the outlet;
d) placing a positive displacement pump downstream of said outlet and in fluid communication with the discharge pipe section, said pump positioned to transmit the fluid from the outlet into the discharge pipe downstream of the pipe section;
e) selectively transmitting the fluid into the well or not circulating the fluid into the well; and
f) wherein in step “e” a mixer inside the vessel enables the viscous material to be stirred, the mixer rotated with a drive shaft.

2. The method of claim 1 wherein in step “d” the pump includes screw conveyor.

3. The method of claim 1 wherein the side wall extends to the outlet and placing the positive displacement pump entirely below the vessel side wall.

4. The method of claim 1 wherein in step “b” the viscous material includes a fluid loss control product.

5. (canceled)

6. The method of claim 1 wherein the vessel gradually tapers downwardly to provide a larger upper portion and a smaller lower portion.

7-8. (canceled)

9. The method of claim 2 wherein drive shaft extends above the vessel top.

10. A method of transmitting a viscous polymeric fluid material into an oil well bore, comprising the steps of:
a) providing a frame supporting a vessel, the frame having a lower end portion that engages an underlying support surface and spacing the vessel above the underlying support surface, the vessel having an interior, upper and lower end portions, a vessel side wall, and an outlet for discharging the fluid from the vessel;
b) adding a polymeric fluid material to the vessel interior that is a fluid loss control product;
c) placing a discharge pipe section below the vessel, the discharge pipe section being in communication with the outlet;
d) placing a positive displacement pump in fluid communication with the discharge pipe, said pump transmitting the fluid from the outlet into the discharge pipe downstream of the vessel outlet;
e) selectively transmitting the fluid to either into the well or not transmitting the fluid into the well; and
f) wherein in step “e” a mixer inside the vessel enables the polymeric fluid material to be stirred, the mixer rotated with a drive shaft motor drive.

11. The method of claim 10 wherein a drive shaft rotates the mixer and the drive shaft extends above the vessel.

12. The method of claim 10 wherein in step “d” the mixer includes an auger.

13. The method of claim 10 wherein the side wall extends to the outlet and placing the positive displacement pump entirely below the side wall.

14. (canceled)

15. The method of claim 10 further comprising adding air to the discharge pipe section downstream of the outlet.

16. The method of claim 10 wherein the vessel gradually tapers downwardly to provide a larger upper portion and a smaller lower portion.

17. The method of claim 12 wherein a drive shaft rotates the mixer inside the vessel.

18. The method of claim 17 wherein the drive shaft rotates the mixer and part of the pump.

19. The method of claim 12 wherein the drive shaft attaches to a motor drive above the vessel.

20. (canceled)
